(19) United States
(12) Patent Application Publication
(10) Pub. No.: US 2015/0305349 A1
(43) Pub. Date: Oct. 29, 2015

(54) WAFFLE BOWL

(71) Applicants: Jeffrey Karl Johnson, Minneapolis, MN (US); Ozmo William Johnson, Minneapolis, MN (US)

(72) Inventors: Jeffrey Karl Johnson, Minneapolis, MN (US); Ozmo William Johnson, Minneapolis, MN (US)

(21) Appl. No.: 14/693,665

(22) Filed: Apr. 22, 2015

Related U.S. Application Data
(60) Provisional application No. 61/983,338, filed on Apr. 23, 2014.

(51) Int. Cl. A21D 13/00; A21D 15/02; A47J 37/06

(52) U.S. Cl. CPC A21D 13/009; A47J 37/0611; A21D 15/02

(57) ABSTRACT

An improved waffle, a device for making the improved waffle, and a method of making the improved waffles are provided. In one embodiment, the waffle includes a side wall, thereby defining a bowl shaped structure. The bowl shaped waffle provides a number of functional advantages over prior art waffles. For example, they can be used to create full healthy breakfast meals including serving as a bowl for oatmeal, scrambled eggs, cut fruit, etc. The waffle also makes breakfast foods more portable as there is no need to clean and store a traditional non-edible bowl. Also, the waffle eliminates waste as there is nothing to discard (e.g., paper bowl or styrofoam bowls). A device for making waffles and a method of making waffles related products are also provided. The method and device can be employed to make a frozen breakfast waffle product for sale at groceries. The waffles according to some of the disclose embodiments are made of a slightly raised flour batter.

### CROSS REFERENCE TO RELATED APPLICATIONS

This application claims the benefit of U.S. Provisional Patent Application Ser. No. 61/983,338 filed Apr. 23, 2014, which is incorporated herein by reference in its entirety.

### BACKGROUND

Waffles are a traditional breakfast food. They are generally made in waffle makers from a flour based batter. They generally include an array of recesses on both a top surface and a bottom surface. The recesses function to receive syrup, whipped cream, butter and berries. There is a need in the art for improved waffles, devices for making improved waffles, as well as methods for making improved waffles.

### SUMMARY

The present disclosure provides an improved waffle, a device for making the improved waffle, and a method of making the improved waffles. In one embodiment, the waffle includes a side wall, thereby defining a bowl shaped structure. The bowl shaped waffle provides a number of functional advantages over prior art waffles. For example, they can be used to create full healthy breakfast meals including serving as a bowl for oatmeal, scrambled eggs, cut fruit, etc. The waffle also makes breakfast foods more portable as there is no need to clean and store a traditional non-edible bowl. Also, the waffle eliminates waste as there is nothing to discard (e.g., paper bowl or styrofoam bowls).

A device for making waffles and a method of making waffles related products are also provided. The method and device can be employed to make a frozen breakfast waffle product for sale at groceries. The waffles according to some of the disclose embodiments are made of a slightly raised flour batter.

### BRIEF DESCRIPTION OF THE DRAWINGS

FIG. 1 is an isometric view of an embodiment of a waffle according to the principles of the present disclosure;

FIG. 2 is a cross-sectional view of the waffle of FIG. 1;

FIG. 3 is an isometric view of an embodiment of a waffle maker according to the principles of the preset disclosure;

FIG. 4 is a cross-sectional view of the waffle maker of FIG. 3;

FIG. 5 is a cross-sectional view of a first alternative embodiment of the waffle of FIG. 1;

FIG. 6 is a cross-sectional view of a second alternative embodiment of the waffle of FIG. 1;

FIG. 7 is a cross-sectional view of a third alternative embodiment of the waffle of FIG. 1; and

FIG. 8 is a cross-sectional view of the waffles shown in a nested stack.

### DETAILED DESCRIPTION

Referring to figures, embodiments of waffles according to principles of the present disclosure are shown. In the one depicted embodiment the waffle 10 has a bowl like shape includes a base 12 having a top surface 14 and a bottom surface 16. In the depicted embodiment the base 12 includes a circular shaped periphery edge 18. In some embodiments the base includes an array of recesses 20 on the top surface 14. In other embodiments the base surface is absent of recesses. In the depicted embodiments, the bottom surface 16 of the base provides a generally planar surface such that the waffle can rest on a table top without easily tipping over. In some embodiments the bottom facing planar surface includes an array of recesses 17. It should be understood that the bottom facing surface can instead be smooth as opposed to including the plurality of recesses. The word “recesses” is used herein to refer generally to topography of any sort including, for example, ridges, depressions, ribs, raise lettering, pockets, etc.

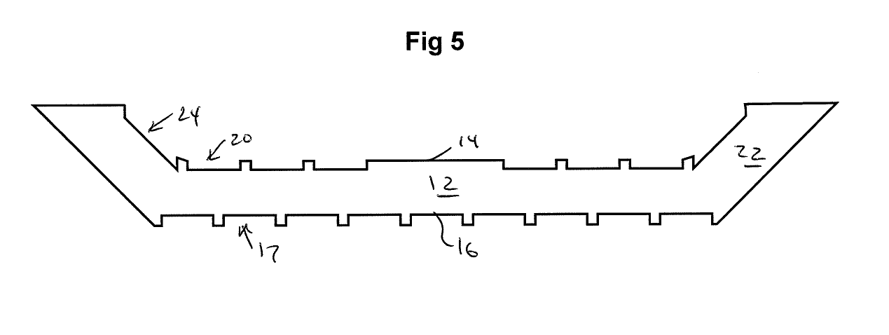

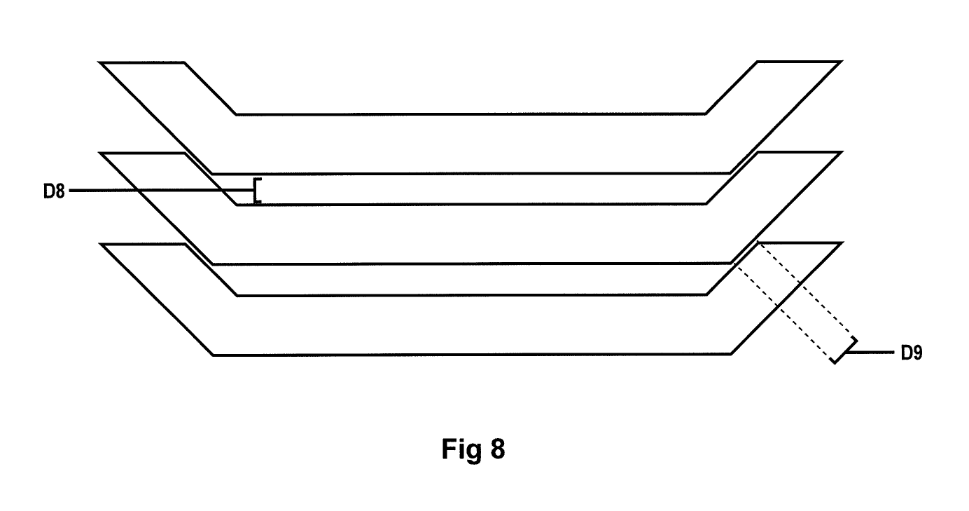

In the depicted embodiment the waffle also includes a side wall 22 extending upwardly from a periphery portion of the base 12. The base 12 and the side wall 22 are integrally formed of the same edible material. In the depicted embodiment the edible material is a flour based batter. In alternative embodiments the edible material could be made of a flourless material. In the depicted embodiment the side wall extends outwardly as well as upwardly from the base, wherein the angle B between the side wall and the base is between 95 to 160 degrees from the base. It should be appreciated that many alternative configurations are also possible. See, for example, FIGS. 5-7 showing some alternative side wall configurations of waffle according to the present disclosure. Being that the waffles according to the present disclosure to some have at least some of the functionality of traditional bowls, they are commonly referred to herein as waffle bowls.

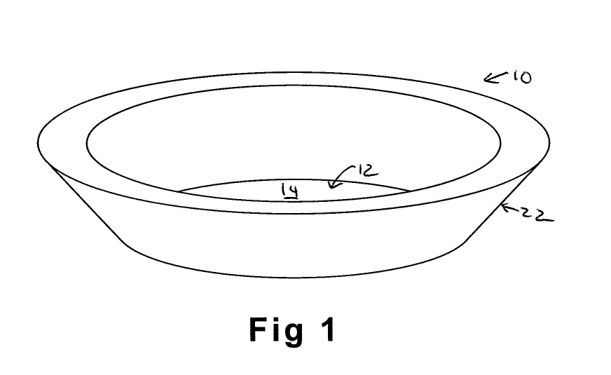

The side wall can have a generally smooth inwardly facing surface as well as a generally smooth outwardly facing surface as shown in FIG. 1. Alternatively, the side wall can have an inwardly facing surface that includes an array of recesses. FIG. 5 illustrates one embodiment where the inwardly facing surface includes recesses 24, whereas the outwardly facing surface is smooth. The recess on the side walls can be configured such that the waffle can be removed from the waffle maker without deflecting the side wall outwardly. For example, the recess can be tapered outwardly from the bottom of the recess towards the top of the recess.

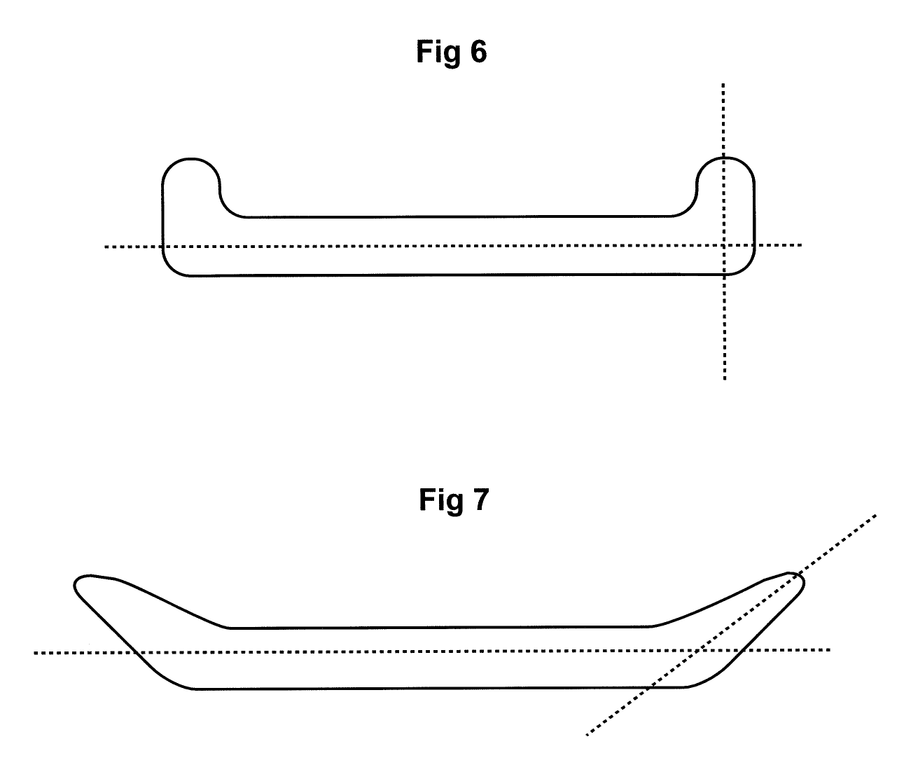

The present disclosure also provides a waffle making device 26 that includes an upper clam shell portion 28, which includes a generally convex shaped non-stick cooking surface, and a lower clam shell portion 30, which includes a generally concaved shaped non-stick cooking surface. In the depicted embodiment the upper and lower clam shell portions are pivotally connected to each other. In the depicted embodiment, the upper clam shell portion 28 and the lower clam shell portion 30 are configured to displace liquid batter material and force the liquid batter to flow upwardly to form a side wall of a waffle. In the depicted embodiment, the cooking surface of the upper portion includes a waffle base upwardly facing surface cooking portion 32, a waffle inside wall surface cooking portion 34, and a waffle top lip cooking portion 36. In the embodiment depicted in FIG. 1, the waffle inside wall surface cooking portion 34 is at an angle between 100 to 160 degrees relative to the waffle upwardly facing surface cooking portion. It should be appreciate that many other configurations are also possible. For example, the waffle inside wall surface cooking portion can be an angle between 120 to 150 degrees relative to the waffle upwardly facing surface cooking portion. Alternative, the angle can be essentially 90 degrees. See FIG. 6.

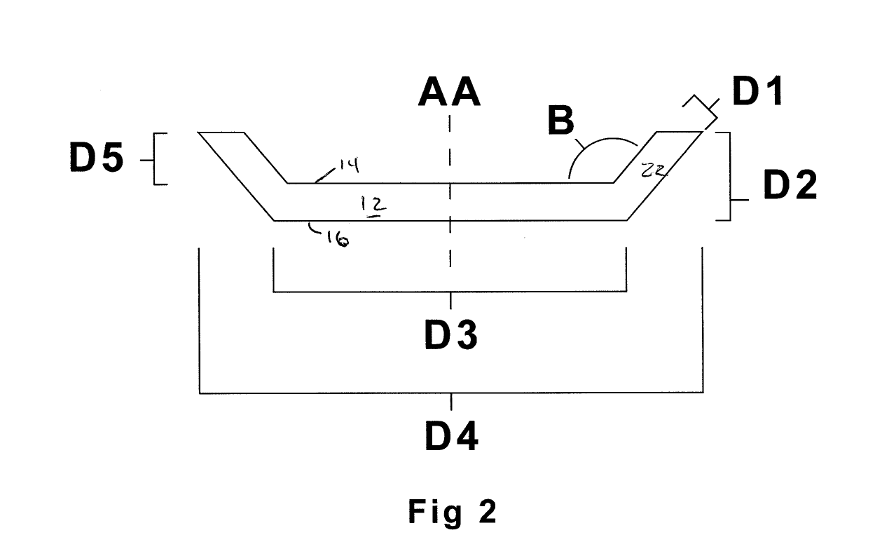

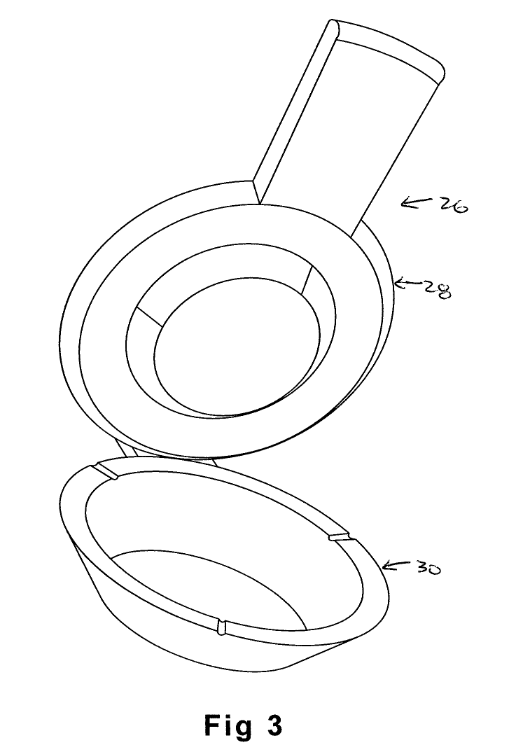

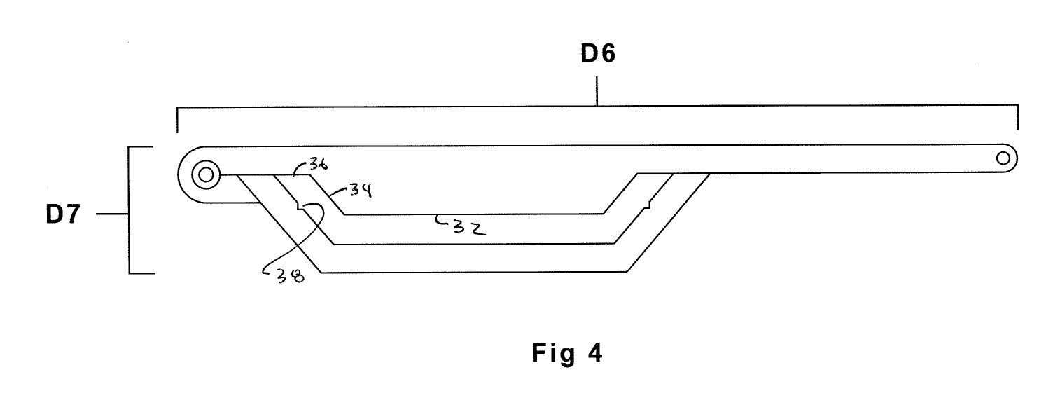

In the depicted embodiment the waffle inside wall surface cooking portion has a vertical height (D5) of between 0.3 to 0.6 inches. See FIG. 2. In the embodiment depicted in FIG. 2 the overall thickness (D2) of between 0.5 to 1.0 inches. In addition, D1 is between 0.3-0.4 inches, D3 is between 3.0-4.0 inches (e.g., 3.5 inches), and D4 is between 4.5-5.5 inches (e.g., 5.0 inches). It should be appreciated that these dimensions match the dimensions of the waffle shown in FIG. 2 that is made by the waffle making device shown in FIGS. 3 and 4.

In the depicted embodiment the waffle maker inside wall surface cooking portion includes a fill indicator marking 38. When batter is filled to the fill indicator marking, a minimal amount of batter will be forced out of the overfull channels 40.

A method of making a waffle is also provided. The method involves using the waffle maker described above to make the waffle described above. The method includes the step of filling the lower clam shell portion with liquid batter to a fill indicator on the lower clam shell portion and lowering the upper clam shell portion into a nested arrangement, thereby forcing batter around the periphery edge. This step brings into contact the cooking surfaces of the waffle maker with the batter to result in a crisp, fully formed waffle structure. For example, this step can bring into contact a waffle top lip cooking portion with the batter to form and crisp an upper lip of the waffle.

The method of making the waffle also can include the step of stacking multiple waffles such that an inner portion of an angled side wall of a lower waffle supports an outer portion of an angled side wall of an adjacent upper waffle. It can further include the step of including stacking multiple waffles such that the upper surface of the base of a lower waffle is spaced away from the bottom surface of the adjacent upper waffle. Once the waffles are stacked and packed, they can be frozen and sold to grocery stores. Consumers can buy the waffles and toast them in a standard toaster to warm them up and further brown them prior to consumption thereof.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A waffle comprising:
a base including a top surface and a bottom surface;
a side wall extending at least upwardly from a periphery portion of the base;
wherein the base and the side wall are integrally formed of the same edible material,
wherein the base includes an array of recesses on at least the top surface, and
wherein the edible material at least includes flour.

2. The waffle of claim 1, wherein the base includes a circular shaped periphery edge.

3. The waffle of claim 1, wherein the bottom surface of the base provides a generally planar surface, wherein the planar surface includes an array of recesses.

4. The waffle of claim 1, wherein the bottom surface of the base provides a generally planar surface, wherein the planar surface is generally smooth.

5. The waffle of claim 1, wherein the side wall extends outwardly as well as upwardly from the base, wherein the angle between the side wall and the base is between 95 to 160 degrees from the base.

6. The waffle of claim 1, wherein the side wall has a generally smooth inwardly facing surface as well as a generally smooth outwardly facing surface.

7. The waffle of claim 1, wherein the side wall has a inwardly facing surface that includes an array of recesses, wherein each recess includes side walls that taper outwardly from the bottom of the recess towards the top of the recess.

8. The waffle of claim 1, wherein the side wall has a inwardly facing surface that includes an array of recesses, wherein each recess is configured such that the waffle can be removed from the waffle maker without deflecting the side wall outwardly.

9. The waffle of claim 1, wherein the side wall is configured such that when the waffle is stacked on top of another identical waffle, the side wall of the waffle engages the side wall of the another identical waffle and the base of the waffle is spaced away from the base of the another identical waffle.

10. A waffle making device comprising:
an upper clam shell portion, wherein the upper clam shell portion includes a generally convex shaped non-stick cooking surface;
a lower clam shell portion, wherein the lower clam shell portion includes a generally concaved shaped non-stick cooking surface;
wherein when the upper clam shell portion and the lower clam shell portion are configured to displace liquid batter material and force the liquid batter to flow upwardly to form a side wall of a waffle, and
wherein the cooking surface of the upper portion includes a waffle bowl base upwardly facing surface cooking portion, a waffle bowl inside wall surface cooking portion, and a waffle bowl top lip cooking portion, wherein the waffle bowl inside wall surface cooking portion is at an angle between 100 to 160 degrees relative to the waffle bowl upwardly facing surface cooking portion.

11. The waffle making device of claim 10, wherein the waffle bowl inside wall surface cooking portion is at an angle between 120 to 150 degrees relative to the waffle bowl upwardly facing surface cooking portion.

12. The waffle making device of claim 10, wherein the waffle bowl inside wall surface cooking portion has a vertical height (D5) of between 0.3 to 0.6 inches.

13. The waffle making device of claim 10, wherein the overall thickness (D2) is between 0.5 to 1.0 inches.

14. The waffle making device of claim 10, wherein the waffle bowl inside wall surface cooking portion includes a fill indicator marking, and wherein the waffle bowl top lip cooking portion includes overfull channels.

15. The waffle making device of claim 10, wherein the upper clam shell portion and the lower clam shell portion are pivotally connected to each other.

16. The method of making a waffle comprising:
providing a waffle making device comprising:
an upper clam shell portion, wherein the upper clam shell portion includes a generally convex shaped non-stick cooking surface, and
a lower clam shell portion, wherein the lower clam shell portion includes a generally concaved shaped non-stick cooking surface;
filling the lower clam shell portion with flour based batter to a fill indicator on the lower clam shell portion; and
lowering the upper clam shell portion into a nested arrangement, thereby forcing batter around the periphery edge.

17. The method of making a waffle of claim 16, further comprising the step of bringing into contact a waffle bowl top lip cooking portion with the batter to form and crisp an upper lip of the waffle bowl.

19. The method of making a waffle of claim 16, further comprising the step of stacking multiple waffles such that an inner portion of an angled side wall of a lower waffle supports an outer portion of an angled side wall of an adjacent upper waffle.

20. The method of making a waffle of claim 16, further comprising the step of stacking multiple waffles such that the upper surface of the base of a lower waffle is spaced away from the bottom surface of the adjacent upper waffle, packaging the stakes of waffle, and freezing the packaged stacks of waffles.
